(19) United States
(12) Patent Application Publication
(10) Pub. No.: US 2016/0345489 A1
(43) Pub. Date: Dec. 1, 2016

(54) Anhydrous Ammonia Fertilizer Apparatus Monitor

(71) Applicants: Douglas L. Litterly, Elkhart, IL (US); Randall S. Litterly, Elkhart, IL (US); Rabah Shaath, Sayre, PA (US); Lauren J. Kiest, Quincy, IL (US)

(72) Inventors: Douglas L. Litterly, Elkhart, IL (US); Randall S. Litterly, Elkhart, IL (US); Rabah Shaath, Sayre, PA (US); Lauren J. Kiest, Quincy, IL (US)

(21) Appl. No.: 14/727,723

(22) Filed: Jun. 1, 2015

(51) Int. Cl. A01C 23/02; A01C 23/00

(52) U.S. Cl. CPC A01C 23/024; A01C 23/007

(57) ABSTRACT

An anhydrous ammonia fertilizer injector includes a tool bar frame with multiple knife injectors. Vapor pressure of the fertilizer forces liquid from a tank through hoses and a vapor separator to a pump. The pump increases pressure above the vapor pressure. Liquid fertilizer passes from the pump through a flow rate sensor, a servo controller and to a manifold. Discharge fittings on the manifold hold orifices. Discharge hoses convey fertilizer from each discharge fitting to each knife. A pressure transducer in each fitting downstream from the orifice sends current pressure readings to a monitor console. The console identifies the largest number of transducer pressures that have readings within a set pressure difference from each reading. The average of the maximum and minimum pressures identified is the center of an acceptable pressure band. A selected deviation sets band limits. The console displays discharge hoses with pressures outside the band limits.

### TECHNICAL FIELD

The present invention relates to a new apparatus and method for monitoring individual rows of anhydrous ammonia fertilizer during agricultural application in fields. More particularly, the invention relates to data collection and analysis during application such that the operator of the applicator can be alerted to deviant performance or unequal row application amounts.

### BACKGROUND OF THE INVENTION

It is desired that ammonia be applied uniformly over a field. One of the main problems in achieving uniformity is difficulty in controlling a stream of mixed liquid and gaseous ammonia.

Injection of anhydrous ammonia into the soil is a commonly used method of supplying nitrogen fertilizer to grain and other crops using an applicator vehicle pulled by a tractor. An ammonia storage tank is pulled behind the applicator. A hose connects the storage tank to the distribution system on the applicator. The distribution system splits the ammonia into separate lines which feed multiple knives. These knives are lowered into the soil several inches and ammonia is injected into the ground at the bottom of the knives as the knives are pulled through the soil.

Friction in the anhydrous ammonia line from a nurse storage tank to the distribution system creates a mixed state of liquid and vapor. Turbine flow meters used to measure the ammonia application rate require that the ammonia be in the liquid state to achieve accuracy. Either of two different options can be used to bring the stream of anhydrous ammonia back to the liquid state for measurement.

Refrigeration has been the typical method of keeping anhydrous ammonia below its saturation temperature and in a liquid state. A typical use of refrigeration is described in U.S. Pat. No. 4,458,609 to Tofte. A part of the liquid ammonia is used as a refrigerant to cool the inlet liquid stream. This is accomplished in a heat exchanger which mechanically separates coolant ammonia from the main liquid ammonia stream. Typically, the refrigerant stream is taken from the main stream at a location downstream from the flow meter. This coolant stream passes through a restriction, losing pressure. The lower pressure, lower temperature stream provides cooling to condense vapor in the inlet liquid ammonia.

Another approach is use of a vapor separator upstream from the flow meter. The vapor separator is described in U.S. Pat. No. 7,096,802 to Kiest. It removes the vapor formed as ammonia liquid passes through the line from the nurse storage tank to the applicator. This vapor stream is minor compared to the main stream of ammonia, typically being less than one percent by weight.

A pump, typically a hydraulically driven centrifugal pump, may be inserted to raise pressure of the ammonia stream above its saturation pressure so as to assure that ammonia remains in the liquid state as necessary for flow measurement.

Previously, the applicator operator has relied on an array of pressure gauges to assure equal row performance of the application system. The array of gauges merely reflects the pressure at the manifold, not individual row conditions. The readings on the array of pressure gauges require the constant attention of the operator, often requiring that he turn to look out the rear window of the tractor to see the gauges.

### SUMMARY OF THE INVENTION

The method and apparatus of the present invention monitors anhydrous ammonia pressure at critical locations along the flow path in the application system by means of electronic pressure transducers. Data from these transducers are used to notify the operator when row to row equality of flow is either present or impaired. A monitor console with colored touch screen panel and audible alarms allows the operator to monitor the row equality during the application process.

Pressure transducers are located at the outlets of single or multiple manifolds where ammonia flow is split among individual knives. Because the ammonia flow rate is normally controlled by a servo valve and not by controlling restrictions between the manifold bodies and their outlets, measuring pressure at these outlets merely measures the pressure inside the manifold at multiple points outside the manifold, indicating nothing of value. For the monitoring to occur, there must be controlling orifices after each line from the manifold but before the location of a pressure monitoring tap. This is a requirement both for arrays of pressure gauges and for arrays of pressure transducers.

The present invention consists of a pressure transducer for each individual line going to a knife for one individual row. Additionally, each manifold has a pressure transducer which measures pressure inside the manifold. Between the manifold transducer and the transducer for one knife is an orifice which controls flow to that knife. All the orifices are normally the same size, an exception being orifices which intentionally supply a differing amount to specific rows, end rows for example. When the orifices are the same size and the upstream manifold pressure is the same and the downstream pressures from the orifices are the same, flow through the orifices is the same. The monitor displays the pressure downstream from each orifice on its touch screen.

Construction of a base value to judge which knife pressures are aberrant is not a simple matter. To understand the concept of monitoring row equality by pressure measurement, one must consider the use of orifices to measure flow. If a pressure reading after an orifice (and before an individual knife) is different from the other knives, flow to that knife is then out of the desired range. The two most common reasons for aberrant flow are a plugged orifice after the manifold and a plugged steel tube which conveys ammonia to the ground. A plugged steel injector tube causes an elevated pressure reading, generally equal to the manifold pressure. A plugged orifice stops flow such that pressure after the orifice is at or near atmospheric pressure.

Averaging the after-orifice pressure values for all knives can inject an error because the correct average value can be distorted by presence of aberrant high or low values. The present invention uses a clustering concept whereby the multitude of pre-orifice pressures is examined by the monitor console to find the largest cluster comprising values which have the minimum sum of differences between those values and their average. Further, the differences must lie in a given variance of values, for example 10 psi. This variance may be set manually or may be a percentage of average flows. The computation of a practical number that conveys the average of this cluster is performed by executing program code that computes the center point of the largest cluster of readings that fit within a given range, for example 10 psi.

Program code first eliminates all abnormal values as: a. Readings that are practically zero or unrealistically at maximum of scale. b. Those rows/readings selected for exclusion by the operator. These might, for example, include end rows. Desired end rows flow rates may sometimes be one-half or double the flow rates for the majority of the rows.

Program code computes a valid cluster average by examining all readings, one by one, then determining how many readings are within a set pressure difference from each reading, one half of 10 (5) psig for example. The resulting cluster containing the largest number of readings is selected by the program code to be the data from which an average value is computed. For a special case where there exists two clusters of similar validity, the choice of which cluster is actually picked by the monitor console is mute. For that special case, pressure deviations among the rows are so extreme that system is out of control by definition.

Finally, the center point is computed by averaging the maximum reading and minimum readings in the cluster. This number is displayed as a “smart” average and is displayed as a band in a graphical display on the color touch screen display of the monitor console. To indicate which readings are aberrant, any reading outside the band will be highlighted in red color. Also, to alert the operator to a potential problem with monitored pressure, an audible alarm is sounded when condition persists for more than a time interval preset by the operator.

The monitor console displays the group of pressure transducers measuring the pressures after the controlling orifices for each application point of anhydrous ammonia. Individual row data is displayed in the form of bar graphs that have a highlighted span of pressure values of the largest cluster of transducers readings within a small pressure range, 10 psi for example. The monitor console displays the group of pressure transducers measuring the pressures after the controlling orifices for each application point of anhydrous ammonia. Individual row data is displayed in the form of bar graphs that have a highlighted span of pressure values of the largest cluster of transducers readings within a small pressure range, 10 psi for example. Bar graphs representing readings outside the majority cluster are emphasized visually or highlighted in differentiation to attract the attention of the operator to help the operator in spotting abnormal pressure readings. Individual row data is also displayed as numerical data for each row.

### BRIEF DESCRIPTION OF DRAWINGS

These and other objects, features and advantages of this invention will become readily apparent in view of the following detailed description of the preferred embodiments and best mode, appended claims and accompanying drawings, in which:

FIG. 1 is a side elevation of the apparatus of the present invention being pulled behind a tow vehicle;

FIG. 2 is an isometric enlargement of the main platform of the present invention;

FIG. 3 is an isometric enlargement of a typical distribution manifold;

FIG. 4 is an isometric rear view of the application toolbar; and

FIG. 5 is a depiction of the screen of the monitor console displaying continuous updates of individual knife line pressures and calculated data describing the operation of the fertilizer distribution system.

### DETAILED DESCRIPTION OF THE PREFERRED EMBODIMENTS

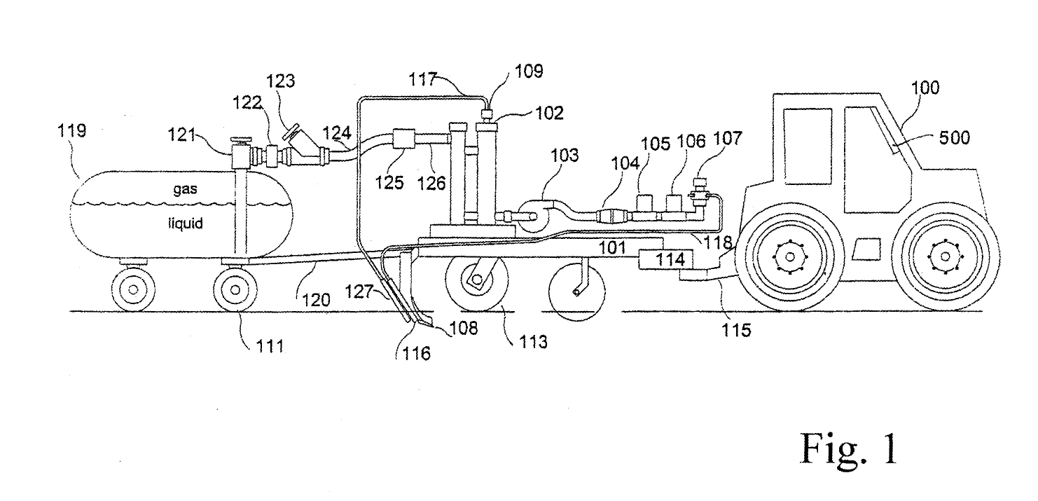

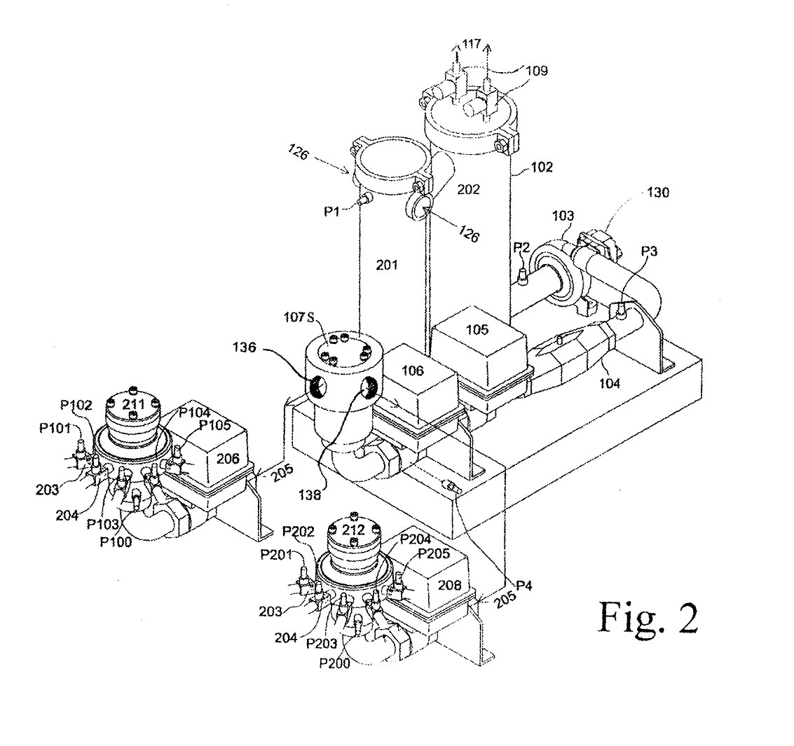

Referring first to FIG. 1 and FIG. 2, the apparatus of the present invention is shown being pulled behind a tow vehicle 100 which could be a tractor, truck, or the like. The apparatus includes a toolbar applicator frame 101 which supports a vapor separation device 102 as described in U.S. Pat. No. 7,096,802 to Kiest and as modified in U.S. Patent Pending, a pressure boosting pump 103, a flow sensor 104, an electrically operated servo control valve 105, an electrically operated off-on valve 106, and a splitter manifold 107. The splitter manifold connects through hoses 205 to distribution manifolds 211 and 212. Vapor from the vapor separating device 102 is intermittently released by an electrically operated solenoid valve 109 through a hose 117 to a second injection tube 127 on one of the injection devices 108. A storage tank 119 is supported on a plurality of wheels 111 and towed behind the toolbar applicator frame 101 by a tongue 120. The toolbar applicator frame 101 is supported on a plurality of wheels 113 and has a tongue 114 that is pivotally connected to a hitch 115 on the rear of the tow vehicle 100. In the preferred embodiment, the toolbar applicator frame 101 is a Progressive series 1300 NH3 Toolbar, manufactured by Progressive Farm Products, Inc. of Hudson, Ill. It is configured by Progressive for “strip till” ammonia fertilizer application. Multiple knives 108 are suspended from the frame 101, typically 8, 12, or 16 of the knives 108 attached to a toolbar applicator frame 101, which is adapted to raise or lower the knives 108 into the soil. Each knife 108 includes at least one injector nozzle 116 through which the ammonia can be emitted into the soil when the knife 108 is lowered into the soil.

The flow stream of anhydrous ammonia passes upward from the supply tank 119 through an appropriate manually-operable shutoff valve 121, a quick connect coupling 122, a globe valve 123 to a hose 124. The main delivery hose 124 goes to a breakaway coupling 125 on the toolbar applicator frame 101. A shorter hose 126 connects from the breakaway coupling 125 to a vapor separation device 102. The main delivery hose 124 and the second hose 126 would be, by way of example, 1.5″ internal diameter (“I.D.”) reinforced EPDM-lined hose.

Liquid anhydrous ammonia in the storage tank 119 is a saturated liquid at its vaporization temperature. As the liquid stream passes through valves, fittings and a connecting hose to the applicator system it experiences a pressure loss due to friction in the hose. Because of the lowered pressure some liquid ammonia vaporizes to cool the liquid to the saturation temperature associated with that lower pressure. This changes the liquid stream into a mixture of liquid and vapor phases. The greater the pressure drop, the greater is the ratio of vapor to liquid. This accumulated vapor is separated out by the vapor separation device 102. The vapor separation device consists of a filter tower 201 containing a filter basket which feeds a separation tower 202. A pressure transducer P1, specifically part number G27M01RMGN200#-#1831, manufactured by Ashcroft of Stanford, Conn., is located in the cavity at the top of the filter tower 201 where the feed hose 126 enters. Separated vapor exits through solenoid valves 109 at the top of the separator tower 202 while pure liquid exits the bottom of the tower 202. An increase in liquid pressure at the exit of the separation tower 202 is caused by static head in the separation tower 202. This pressure increase raises the pressure of the liquid above saturation pressure. Liquid pressure at the entrance to the pump 103 is measured by pressure transducer P2.

The apparatus of the current invention would preferably include a centrifugal pump 103, such as of the type manufactured under model 9303S or model 9306S by Hypro Corporation of New Brighton, Minn. In the preferred embodiment, the pump 103 is driven by a hydraulic motor 130, using tractor hydraulics.

Following the pump 103 is a pressure sensor P3 and then a flow sensor 104 which is connected to a console/controller 500 in the cab of the tow vehicle 100 so that the operator of the tow vehicle 100 can monitor and control the flow of ammonia through a servo valve 105. Following the servo valve 105 the liquid ammonia flows to a electrically operated shut off valve 106. A pressure transducer P4 measures downstream pressure after the servo valve 105. After the shut off valve 106 is a splitter manifold 107 S which divides the ammonia stream received from the servo valve 105. As shown in FIG. 2, the splitter manifold 107 S divides ammonia between distribution manifolds 211 and 212 through hoses 205. One hose 205 is connected to a discharge port 136 on the splitter manifold 107 S and to distribution manifold 211. A second hose 205 is connected to a discharge port 138 on the splitter manifold 107 S and to distribution manifold 212.

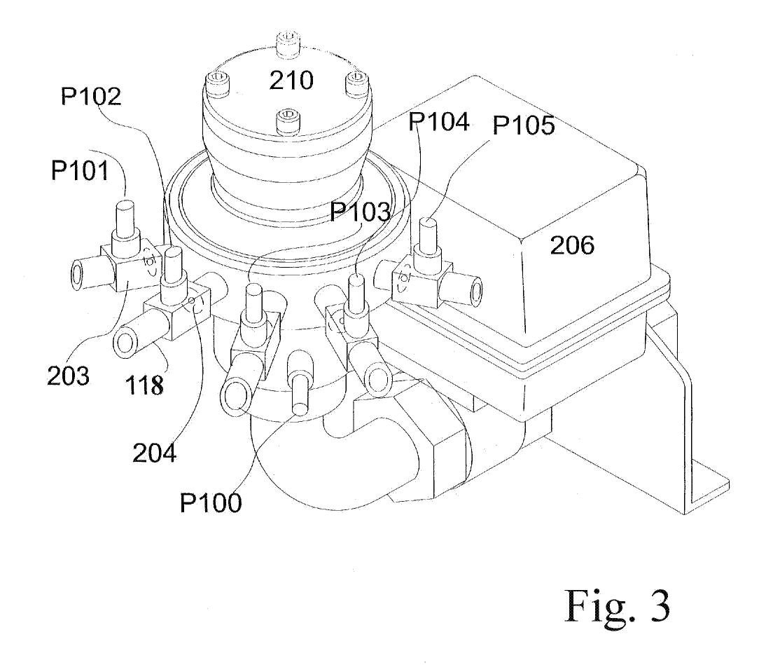

Exiting the manifolds 211 and 212 as shown in FIG. 2 and FIG. 3 is a fitting 203 which houses an orifice 204. Fitting 203 has a connection downstream from the orifice 204 to accept a pressure transducer P101, for example. Also, the fitting 203 has a connection downstream from the orifice 204 for connection of the hose 118 to the knife 108.

Each knife 108 has an orifice 204 which creates a back pressure on manifolds 211 and 212, maintaining the ammonia as a liquid at a pressure above its saturation pressure. The orifices 204 provide equal flow to each knife line. Flexible hoses 118 connect the manifolds 211 and 212 to the knives 108.

Electrically operated shut-off valves 106, 206 and 208 interrupt ammonia flow when the applicator frame 101 is lifted at the end of a row. This reduces escape of ammonia vapor to a minimal amount. At the start of a new row, shut-off valves 106 and 206 open, allowing ammonia to flow. This procedure eliminates depletion of liquid ammonia, needing much less time to reach equilibrium at the start of a new row.

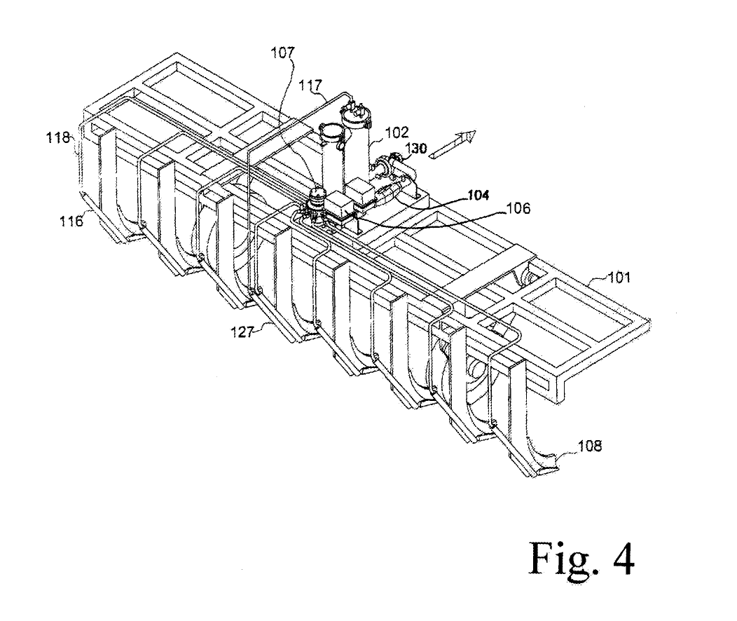

Referring now to FIG. 3 and FIG. 4, ammonia vapor leaving the vapor separation tower 202 passes through a solenoid valve 109 and a hose 117 to a soil injection tube 127 attached to a knife 108. Ammonia for one knife 108 passes through a hose 118 to a knife 108. It is to be noted that each line to a knife has a pressure transducer in the fitting 203. For example, shown in FIG. 2, are transducers P101, P102, P103, P104, and P 105.

As described above, the method and apparatus of the present invention monitors anhydrous ammonia pressure after the orifices in lines 118 to all knives 108. A monitor console 500 with colored touch screen panel and audible alarms 508 allows the operator to immediately determine the operation state during the application process. The desired case is where all pressures are identical and all knife flows are therefore identical.

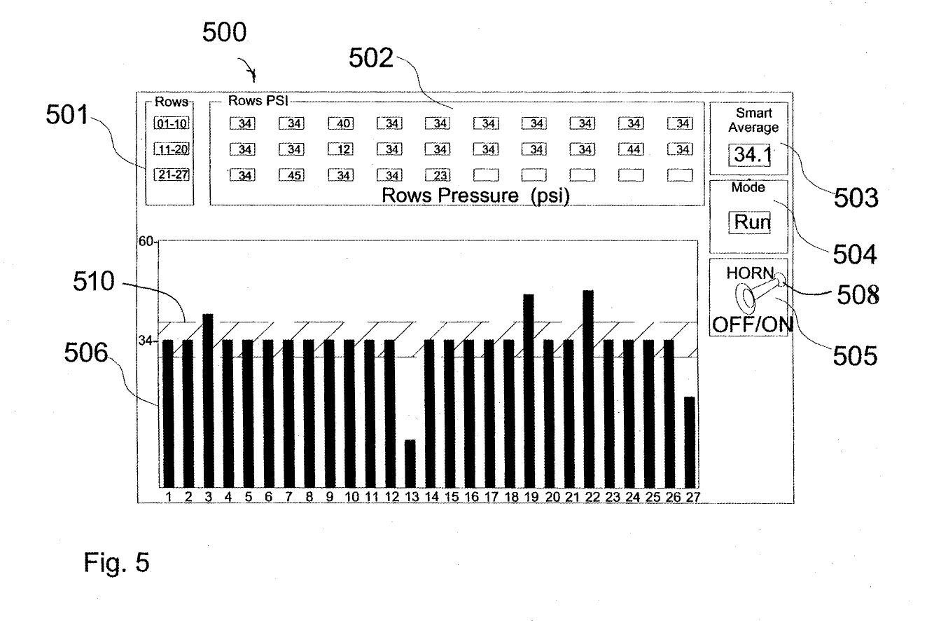

Referring now to FIG. 5, pressures for individual lines 118 going to knives 108 are displayed on the colored touch screen of the monitor console 500. These line pressures, P101 for example, can be numerous, as many as one hundred lines for a large agricultural seeders and fertilizer applications. Screen segment 501 indicates the range of row numbers whose pressures are displayed in a corresponding line to the right in screen segment 502. Additionally, each manifold 211 and 212 has a pressure transducer P100 or P200 which measures pressure inside the manifold. Between the manifold transducer P100, for example, and the transducer P101 for one knife 108, for example, is an orifice 204 which controls flow to that knife 108. All the orifices 204 are normally the same size, an exception being orifices which intentionally supply a differing amount to specific rows, end rows for example. When the orifices 204 are the same size and the upstream and downstream pressures are the same, flows through the orifices 204 are the same. The monitor console 500 displays pressure after each orifice 204 on its touch screen in screen section 502. It is to be noted that the pressures displayed in screen segment 502 show the pressure drop from the orifice 204 to atmospheric pressure at the end of the injector knife 108. Normal restriction to flow through hose 118 is not considered because all the hoses have substantially the same length and size.

Construction of a base value to judge which knife pressures are aberrant is not a simple matter. To understand the concept of monitoring row equality by pressure measurement, one must consider the use of orifices 204 to measure flow. If a pressure reading after an orifice 204 to a knife 108 is different from pressures before the other knives 108, flow to that knife 108 is then out of the desired range. The two most common reasons for aberrant flow are a plugged orifice 204 after the manifold 211 and 212 and a plugged steel tube 116 which conveys ammonia to the ground. A plugged steel injector tube 116 causes an elevated pressure reading, generally equal to the manifold pressure P100 or P 200. A plugged orifice 204 stops flow such that pressure after the orifice 204 is at or near atmospheric pressure. Hoses 118 that are in good condition and properly maintained do not leak or excessively impede flow.

Averaging the after-orifice 204 pressure values for all knives 108 can inject an error if the correct average value is distorted by presence of aberrant high or low values. The present invention uses a clustering concept whereby the multitude of pre-orifice pressures is examined by the monitor console to find the largest cluster comprising values which have the minimum sum of differences between those values and their average. Further, the differences must lie in a given variance of values, for example 10 psi. This variance may be set manually or may be a percentage of average flows, +/−5% for example. The computation of a practical number that indicates the average for this cluster is performed by executing program code that computes the center point of the largest cluster of readings that fit within a given range, for example 10 psi.

Program code first eliminates all abnormal values as: a. After orifice 204 pressure readings that are practically zero or unrealistically at maximum of scale. b. Pressure readings for rows selected for exclusion by the operator. These might, for example, include end rows. Desired end rows flow rates may sometimes be one-half or double the flow rates for the majority of the rows.

Program code computes a valid cluster average by examining all readings, one by one, then determining how many readings are within a set pressure difference from each reading, +/−5 psig for example. The resulting cluster containing the largest number of readings is selected by the program code to be the data from which an average value is computed. For a special case where there exists two clusters of similar validity, the choice of which cluster is actually picked by the monitor console is mute. For that special case, pressure deviations among the rows are so extreme that system is out of control by definition.

Finally, the center point is computed by averaging the maximum and minimum readings in the cluster. This number is displayed as a “smart” average and is displayed as in screen segment 503.

The monitor console calculates a band width of acceptable pressures based on the “smart” average and the allowable deviation. A possible band 510 is shown in FIG. 5. To indicate which readings are aberrant, any reading outside the band width is highlighted in red color. Also, to alert the operator to a potential problem with monitored pressure, an audible alarm 508 is sounded when condition persists for more than a time interval preset by the operator.

Screen segment 506 on the monitor console displays individual row pressures displayed in the form of a bar graph. A highlighted span of acceptable pressure values as determined above displays as a background for the bar graph. Bar graphs representing readings outside the majority cluster are emphasized visually to attract the attention of the operator. An audible alarm also helps the operator in spotting abnormal pressure readings.

Screen segment 504 displays the work “RUN” when the application system is applying ammonia fertilizer and the word “HOLD” when application is stopped as at the ends of rows.

Screen segment 505 is toggled when touched by the operator. If the monitor console sends an audible alarm when a system malfunction is detected, the operator can turn off the alarm by touching segment 505.

I claim:

1. An anhydrous ammonia fertilizer applicator comprising:
a toolbar frame attachable to a tractor, a plurality of injection knives attached to the toolbar frame and movable into engagement with soil to form slits in soil when the toolbar frame moves forward;
an anhydrous ammonia storage tank connected to the toolbar;
a vapor separation device mounted on the toolbar frame and connected to the anhydrous ammonia storage tank by a main delivery hose;
a pressure boosting pump mounted on the toolbar frame and connected to the vapor separation device to receive liquid anhydrous ammonia from the vapor separation device;
a flow sensor mounted on the toolbar frame and operable to measure flow rate of anhydrous ammonia received from the pressure boosting pump;
a servo control valve mounted on the toolbar frame and operable to control flow rate of anhydrous ammonia received from the flow sensor;
a distribution manifold mounted on the toolbar frame, connected to the servo control valve to receive anhydrous ammonia from the servo control valve, a plurality of fittings on the distribution manifold each of which has an orifice with a selected size for the passage of anhydrous ammonia from the distribution manifold, a plurality of flexible hoses each of which is connected to one of the plurality of fittings and to one of the plurality of injection knives, and a pressure transducer in each of the plurality of fittings downstream from the orifice; and
a monitor console that receives pressures from each of the pressure transducers and identifies each of the plurality of flexible hoses that has an abnormal pressure downstream from the orifice.

2. The anhydrous ammonia fertilizer applicator, as set forth in claim 1, including an off-on valve between the servo control valve and the distribution manifold and operable to stop flow of anhydrous ammonia from the servo control valve to the distribution manifold when off.

3. The anhydrous ammonia fertilizer applicator, as set forth in claim 1, wherein the monitor console displays a bar graph representing the pressure measurements provided by the pressure transducer in each of the plurality of fittings downstream from the orifice.

4. The anhydrous ammonia fertilizer applicator, as set forth in claim 3, wherein the monitor console also displays a pressure band with a width that represents the maximum and minimum pressures for acceptable anhydrous ammonia application based on an average pressure of the maximum pressure and minimum pressure measurements within the pressure band.

5. The anhydrous ammonia fertilizer applicator, as set forth in claim 4, wherein the pressure deviation from the average pressure is selected and changeable.

6. The anhydrous ammonia fertilizer applicator, as set forth in claim 2, wherein monitor console cancels past pressures received from each of the pressure transducers when the off-on valve is closed and displays new pressures after the off-on valve is opened and flow of anhydrous ammonia resumes.

7. An anhydrous ammonia fertilizer applicator comprising:
a toolbar frame attachable to a tractor, a plurality of injection knives attached to the toolbar frame and movable into engagement with soil to form slits in soil when the toolbar frame moves forward;
an anhydrous ammonia storage tank connected to the toolbar;
a vapor separation device mounted on the toolbar frame and connected to the anhydrous ammonia storage tank by a main delivery hose;
a pressure boosting pump mounted on the toolbar frame and connected to the vapor separation device to receive liquid anhydrous ammonia from the vapor separation device;
a flow sensor mounted on the toolbar frame and operable to measure flow rate of anhydrous ammonia received from the pressure boosting pump;
a servo control valve mounted on the toolbar frame and operable to control flow rate of anhydrous ammonia received from the flow sensor;
a splitter manifold with a splitter manifold inlet port receiving anhydrous ammonia from the servo control valve, and wherein the splitter manifold includes at least a first anhydrous ammonia outlet port and a second anhydrous ammonia outlet port;
a first distribution manifold mounted on the toolbar frame, connected to the first anhydrous ammonia outlet port of the splitter manifold by a first hose, a plurality of fittings on the first distribution manifold each of which has an orifice with a selected size for the passage of anhydrous ammonia from the first distribution manifold, a plurality of flexible hoses each of which is connected to one of the plurality of fittings and to one of the plurality of injection knives, and a pressure transducer in each of the plurality of fittings downstream from the orifice;
a second distribution manifold mounted on the toolbar frame, connected to the second anhydrous ammonia outlet port of the splitter manifold by a second hose, a plurality of fittings on the second distribution manifold each of which has an orifice with a selected size for the passage of anhydrous ammonia from the second distribution manifold, a plurality of flexible hoses each of which is connected to one of the plurality of fittings and to one of the plurality of injection knives, and a pressure transducer in each of the plurality of fittings downstream from the orifice; and
a monitor console that receives pressures from each of the pressure transducers and identifies each of the plurality of flexible hoses that has an abnormal pressure downstream from the orifice.

8. The anhydrous ammonia fertilizer applicator, as set forth in claim 7, including a primary off-on valve between the servo control valve and the inlet to the splitter manifold, a first distribution manifold off-on valve between the first anhydrous ammonia outlet port and the first distribution and in the flow of anhydrous ammonia through the first hose, a second distribution manifold off-on valve between the second anhydrous ammonia outlet port and the second distribution manifold and in the flow path of anhydrous ammonia through the second hose and wherein the primary off-on valve, the first distribution manifold off-on valve and the second distribution manifold off-on valve are on during application of anhydrous ammonia fertilizer and wherein the primary off-on valve, the first distribution manifold off-on valve and the second distribution manifold off-on valve are off when application of anhydrous ammonia fertilizer is discontinued.

9. The anhydrous ammonia fertilizer applicator, as set forth in claim 7, wherein the monitor console displays a bar graph representing the pressure measurements provided by the pressure transducer in each of the plurality of fittings on the first distribution manifold downstream from the orifice and on the second distribution manifold downstream from the orifice.

10. The anhydrous ammonia fertilizer applicator, as set forth in claim 9, wherein the monitor console also displays a pressure band with a band width that represents the maximum and minimum pressures for acceptable anhydrous ammonia application based on an average pressure of the maximum pressure and the minimum pressure measurements within the pressure band.

11. The anhydrous ammonia fertilizer applicator, as set forth in claim 10, wherein the band width from the average pressure is selected and changeable.

12. The anhydrous ammonia fertilizer applicator, as set forth in claim 8, wherein the primary off-on valve, the first distributor manifold off-on valve and the second distribution manifold off-on valve are switched to on to resume the flow of anhydrous ammonia fertilizer and the monitor console receives current pressures from the pressure transducers.

13. The anhydrous ammonia fertilizer applicator, as set forth in claim 12, wherein the monitor console displays a pressure band with a width that represents a maximum and a minimum pressure for acceptable anhydrous ammonia application with current pressures.
